(19) United States
(12) Patent Application Publication
(10) Pub. No.: US 2004/0210465 A1
(43) Pub. Date: Oct. 21, 2004

(54) Shared environment management system for the industrial organization

(76) Inventors: Hiroshi Inanaga, Tokyo (JP); Shoji Karasumi, Saitama (JP)

Correspondence Address: BROOKS KUSHMAN P.C., 1000 TOWN CENTER, TWENTY-SECOND FLOOR, SOUTHFIELD, MI, 48075, US

(21) Appl. No.: 10/478,629

(22) PCT Filed: May 25, 2001
(86) PCT No.: PCT/JP01/04410

(51) Int. Cl. G06F 17/60

(52) U.S. Cl. 705/7

(57) ABSTRACT

The present invention provides a shared environment management system by organization characterized, in that in a network which consists of a management company, a plurality of organization management centers, and a plurality of member companies belonging to each of the organization management centers. Each of the organization management centers includes means for receiving the shared environment management system by organization from the management company, means for inputting legal regulations, means for inputting an environmental influence evaluation table, means for receiving a result of checking legal regulation application items from each of the member companies, means for receiving a result of conducting environment management from each of the member companies, means for instructing each of the member companies based on results of collection and analysis, and means for interpreting application of new legal regulations, and for notifying the management company of application items of the new legal regulations and means for reviewing environmental influence evaluation items.

### FIELD OF THE INVENTION

The present invention relates to an environment management system. More specifically, the present invention relates to a shared environment management system built on a web site on the Internet according to each type of industry or each industrial organization (hereinafter referred to as “for the industrial organization” collectively).

### BACKGROUND OF THE INVENTION

At the present day, environmental issues are important management subjects by which company management is unavoidably confronted. Domestically, legal regulations centered around the Basic Environment Law have been prepared to address the environmental issues. Globally, International Environment Management System Standards IS014001 have been enacted and JIS standards corresponding to this standards are now being prepared. The IS014001 standards consist of a cycle of PLAN, DO, CHECK, and ACTION and are intended to make continuous improvements in the course of this cycle. FIG. 1 illustrates an outline of IS014001 from this viewpoint.

Under these circumstances, to build an environment management system based on the IS014001 standards is a pressing challenge for each company. The environment management means the development of company activities while incorporating an environmental policy into a management policy, making plans based on the environmental policy, and putting such plans into practice. The purpose of environment management is to minimize any influence and risk on the environment caused by activities, products or services of each company and to continuously improve activities to prevent the incident of any influence and risk on the environment.

The influence on the environment (hereinafter referred to as “environmental influence”) means changes in the environment caused by the activities, products or services of an organization, such as a company. It is necessary to distinguish an environmental influence that has an impact particularly and greatly upon the environment and clarify measures and actions to prevent or minimize the incident of such environmental influence. The environment management system means a system that defines an organizational chart, a responsibility, a business practice, procedures, a process, and management resources, and that is voluntarily created and operated at the organization's discretion. The environment management system is a part of the management system for the entire organization of each company.

As for the environment management based on regulations, each country established laws and regulations on the environment management, which it considered necessary to regulate. The laws and regulations intend to set regulatory standards and mandates each company to observe such standards. The environment management system (i) establishes a program so that each company voluntarily clarifies its management policy related to the environment; (ii) evaluates itself as to which aspects of the activities, products or services may effect the environment; (iii) sets a goal for managing environmental aspects that has a great impact on the environment; and (iv) prepares a program to reach the goal. In the environment management system, if such environmental program does not meet the goal, the company is required to take a remedial action to resolve problems. If the company cannot meet its goal because the system does not work sufficiently, the company is required to improve the system. The company is also required to satisfy the standards so as to comply with the regulatory standards.

If each company individually builds its environment management system, it has to bear a time and cost including, but not limited to, the burden of internal personnel placement. For these reasons, there are many companies that hesitate to build their own environment management systems. Further, even if a company builds its environment management system, it is generally based on the individually created documents. Consequently, an industrial organization cannot grasp the content of each company's system on the industry level, and finds it difficult to give any instruction or guidance to the individual company. This makes it difficult to improve the level of environment management system for the entire industry. Particularly, for small and medium companies, it may become a serious management problem to build the environment management system, because the development of the system requires lots of manpower, time and funds.

The present invention has been achieved in light of these circumstances, and provides an environment management system shared by the industrial organization. By providing a standardized shared environment management system for the industrial organization, it becomes possible for each member company to build its own environment management system. Even if the member company cannot assign an internal auditor because of limitations of human resources, such member company, based on the common element of the environment management system, can conduct an internal audit review by utilizing an internal auditor who belongs to the industrial organization and the implementation of the environment management system becomes easy. Further, by providing the shared standardized system, the industrial organization can grasp the content of the environment management system of each member company and can give any instruction and guidance to each member company. The standardized shared environment management system makes it possible to improve the level of environment management of each company as well as the entire industry as a whole.

### SUMMARY OF THE INVENTION

The present invention relates to a shared environment management system by organization characterized, in that in a network which consists of a management company, a plurality of organization management centers, and a plurality of member companies belonging to each of the organization management centers, each of the organization management centers comprising: means for receiving the shared environment management system by organization from the management company; means for inputting legal regulations commonly applicable to the organization; means for storing the legal regulations commonly applicable to the organization; means for inputting an environmental influence evaluation table common to the organization; means for storing the environmental influence evaluation table common to the organization; means for providing the shared environmental management system by organization to each of the member companies; means for receiving a result of checking legal regulation application items from each of the member companies; means for receiving added environmental influence evaluation items; means for receiving a result of conducting environment management from each of the member companies; means for collecting and analyzing performances of each of the member companies; means for instructing each of the member companies based on results of collection and analysis; means for interpreting application of new legal regulations, and for notifying the management company of application items of the new legal regulations; and means for reviewing environmental influence evaluation items, and for notifying the management company of reviewed results. Further, this shared environment management system by organization may comprises means for conducting an environmental audit of each of the member companies.

The means for receiving the results of conducting the environment management from each of the member companies comprises: means for receiving an education conducting report created by each of the member companies; and means for receiving minutes created by each of the member companies. In addition, the means for conducting the environmental audit of each of the member companies comprises: means for determining compatibility of various documents prepared by each of the member companies; means for preparing an audit report; and means for notifying each of the member companies of the prepared audit report.

Further, each of the management centers may comprise; means for urging the management company to update the shared environment management system based on the newly interpreted application of the new legal regulations and the reviewed environmental influence evaluation items; and means for urging the management company to urge each of the member companies to update the shared environment management system.

Each of the management centers may also comprise means for urging the management company to conduct the environmental audit of each of the member companies in response to a request from each of the member companies.

The various management centers can establish a hierarchically different level (s) of organization management center (s) in accordance with each type of industry or each an industry.

Further, as for the management company, the gist of the present invention is a shared environment management system by organization characterized in that, in a network which consists of a management company, a plurality of organization management centers, and a plurality of member companies belonging to each of the organization management centers, the management company comprising: means for providing the shared environment management system by organization to each of the organization management centers; means for receiving new legal regulation application items from each of the organization management centers; means for receiving a review result of environmental influence evaluation items from each of the organization management centers; means for updating the shared environment management system by organization; and means for providing the updated shared environment management system by organization to each of the organization management centers. The management company can comprise means for conducting an environmental audit of each of the member companies.

As for the updated system, each of the management centers can comprise: means for receiving the updated shared environment management system for the industrial organization; and means for providing the updated shared environment management system for each of the member companies.

The present invention is characterized by the fact that even a small or medium company that has insufficient management resources such as staff and funds can easily obtain an environment management system that is equivalent to the one utilized by a larger company that has sufficient management resources. Therefore, the present invention provides a standardized organizational environment management system that can be shared and utilized as a shared environment management system by each type of industry or each industry. As a result, each of the member companies can build its own environment management system based on the standardized environment management system shared by the industrial organization. Even if the company cannot place an internal auditor due to limitations on human resources, an auditor who belongs to the management centers can conduct an internal audit, because there is a common element of the standardized environmental management system shared by the industrial organization. Furthermore, since the present invention has a mechanism with which each management center can interpret the content of the environment management system of each member company, the management center, from time to time, gives an instruction and guidance to each member company and as a result, the level of environment management system of the entire industry can be improved.

### BRIEF DESCRIPTION OF THE DRAWINGS

FIG. 1 is an illustration that explains principal points of IS014001.

FIG. 2 illustrates one example of the configuration of a shared environment management system for the industrial organization.

FIG. 3 illustrates one example of an environmental influence assessment sheet.

FIG. 4 illustrates one practical application of the shared environment management system for the industrial organization, and

FIG. 5 illustrates another practical application of the shared environment management system for the industrial organization.

### DETAILED DESCRIPTION

The present invention will be described hereinafter with respect to its practical application. The present invention regarding a shared environment management system for the industrial organization is operated within the network that is composed of management companies, various management centers, and various member companies that participate in the several management centers. The network will be described mainly centered around the Internet; however, the network is not limited to the Internet and may be restricted by a membership. Management Companies, various management centers and member companies that participates in management various management centers, actually form a network through the computers that respectively belong to each organization. Each computer includes, but not limited to, a central processing unit, an internal storage device, an external storage device, an output device, an input device, a display device, and a communication device.

A management company is provided with a management computer; management centers are provided with an organization computer; and a member company that participates in the said network is provided with a corporate computer. In addition, an audit computer is provided to each or one of the management companies and/or each management center. Various management centers are connected to the management company and various member companies are connected to each of the management centers. Each management center is established for each industry or each type of the industry to which the management center belongs. The member companies participate in the management centers corresponding to each industry or each type of the industry to which the member companies belong. Various management centers can jointly form another level of management centers, and such management centers can belong to a management company by using a hierarchical structure.

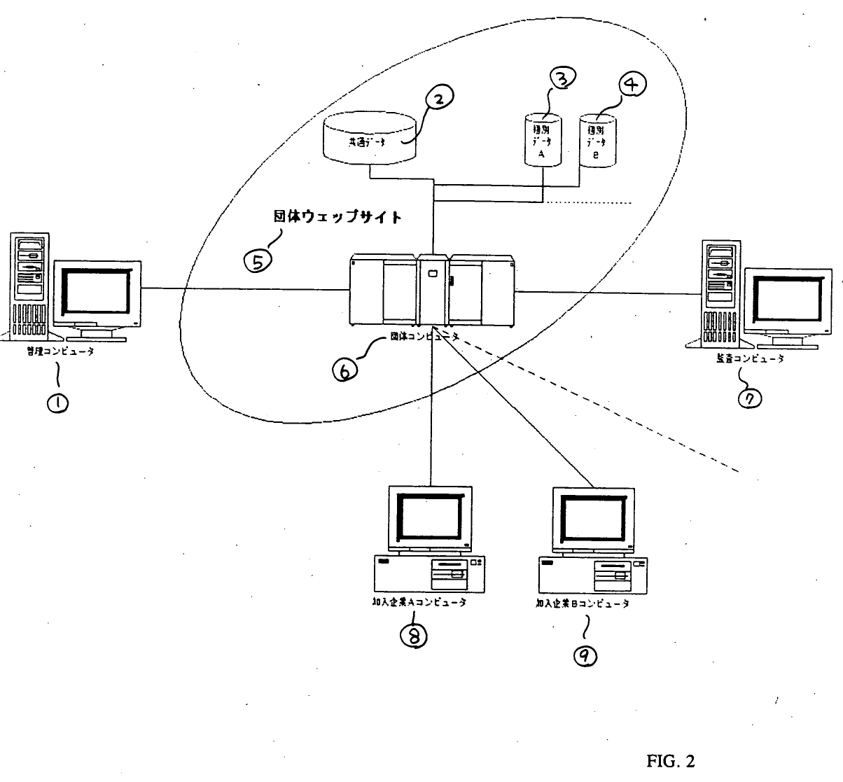

The system covered by the present invention forms computer networks. That is, the computer networks consist of four groups of computers such as organization computers, member company computers, audit computers and management computers. Each organization computer stores both industrial organization's common data and member companies' individual data. This situation is shown in FIG. 2. As described above, the audit computer belongs to each of or one of the management companies and/or management centers. The organization computer provides a web site on the Internet. The web site is accessed (i) by the computer of each member company belonging to the management centers for its own environment management system; (ii) by the management centers for an internal audit; and (iii) by the computer of the management company that manages the standardized environment management system.

The main relationship among the management company, each management center, and each member company is as follows. The management company cooperates with the management center in advance and provides a standardized shared environment management system to the organization computer of relevant management centers, and thereby, builds an environment management system for each member company. The management company provides the system, provides each member company educational training related to system operation, and intends to improve the efficiency of the system operations. The 1 management center permits each member company to build its own environment management system in the organization computer in response to a subscription offer from such member company. The member company connects to the organization computer and builds its environment management system. At this stage, the member company may add regulatory items that are specific to the member company or supplements environmental influence assessment items, if needed.

The member companies, from time to time, execute environment management by accessing the environment management system from its own computer that is equipped with environment management system application. The member company is accessed by the audit computer of the management centers and thus, the environment management system of the member company is subject to an internal audit. In addition, the environment management system can accept an environmental audit review from the management company. The management center researches and analyses the environment management system of each member company and clarifies points or issues that should be improved in the standardized environment management system shared by the industrial organization relevant to the management center. The management company revises the standardized environment management system shared by such industrial organization based on the issues that were found through such research and analysis.

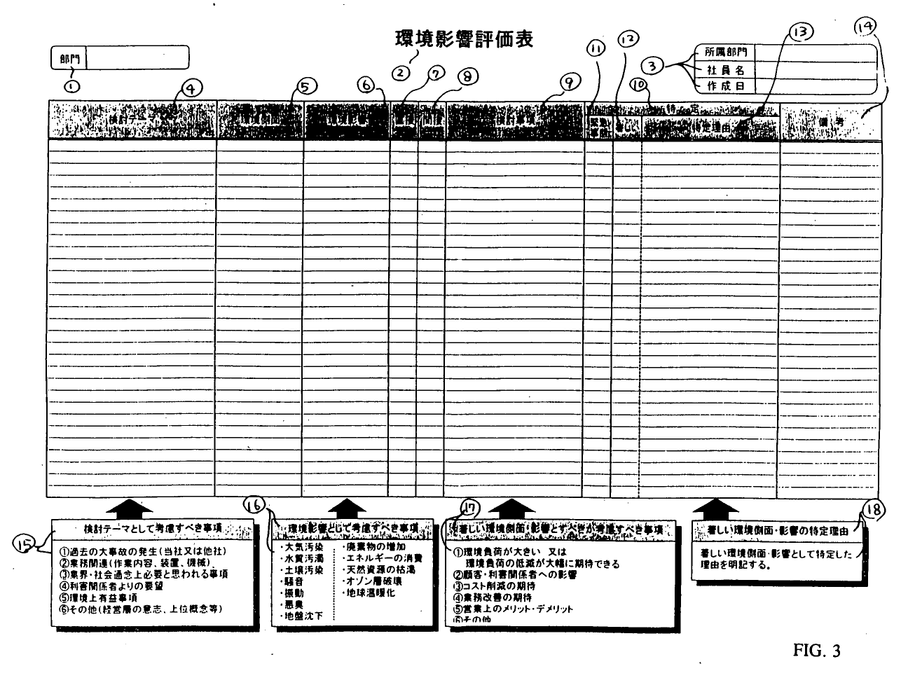

Next, how to build the standardized environment management system that is shared by the industrial organization will be described. The management center is provided by the management company an environment management system relevant to the industry to which the said management center belongs, and builds a standardized shared environment management system for the industrial organization. The management center inputs into the system, as common data, a regulatory item list obtained by extracting regulations applicable to the industrial organization relevant to the management center, and stores such list in the storage device of the organization computer. At the same time, the management center inputs into the system and stores, as common data, the environmental influence assessment sheet that lists and displays the environmental influence assessment items generally applicable to the industrial organization relevant to such management center. FIG. 3 illustrates one example of an environmental influence assessment sheet.

The building and operation of a certain member company's environment management system will be described, centered around, as an example, a member company A. The member company A connects its computer to the organization computer and builds its environment management system based on the standardized shared environment management system for the industrial organization. That is, the member company A inputs its own company information into the standardized shared environment management system for the industrial organization and registers its own environment management system. The member company A opens the regulatory list stored in the standardized shared environment management system for the industrial organization, examines whether any regulatory item is applicable to itself, and checks applicability of each item. This information is stored as regulatory list information on individual company data A. The member company A opens the environmental influence assessment sheet stored in the standardized shared environment management system for the industry organization, examines environmental influence assessment for the company A, and enters environmental influence assessment items which should be added individually besides the general items. This information is stored as environmental influence assessment sheet information for the individual company data A.

The member company A, from time to time, connects to the organization computer from its computer using the environment management system created, accesses its environment management system, and executes the environment management. That is, the member company A inputs information on training conducted into its environment management system based on the achievements of training. This information is stored as a report concerning training information on the individual company data A. The member company A enters minutes made when a meeting was held as internal communication. This information is stored as minute's information on the individual company data A.

The member company A may request the management center to conduct an internal audit, and its environment management system is reviewed by management center by the access from the audit computer of the management center. That is, the management center accesses the individual company data A from the audit computer. The management center determines whether the environment management system of the member company A is pertinent by way of referring to the regulatory list information, including, but not limited to, the environmental influence assessment sheet information, the report concerning training information and the minutes information on the member company A. The management center inputs a conclusion of the audit report on the member company A's environment management system. This information is stored as audit report information on the individual company data A.

The information collection, statistics, and analysis of the shared organization management system for the industrial organization will be described below. The management center collects performance information (e.g., product volumes and raw material consumption volumes) on the environment management systems of member companies in the organization computer and utilizes the information as a part of industrial statistics. That is, the management center analyses the collected information, examines items to be improved, and gives instruction or guidance to each member company. The management center, on behalf of the member company, interprets the application of new regulations and notifies the management company of its application. Further, the management center, from time to time, reviews the environmental influence assessment items, and notifies the management company of the reviewed results.

The update of the shared environment management system for the industrial organization will be described below. The management company revises the standardized environment management system for the industrial organization in response to a request for improvement from the management center and updates the standardized environment management system for the industrial organization in the organization computer. The management company updates and stores data in the organization computer regarding the regulatory items and the environmental influence assessment sheet on the shared environment management system for the industrial organization by utilizing the management computer. The member company updates its own individual data based on the standardized shared environment management system for the industrial organization.

Further, different various environment management systems that may vary depending upon each type of industries or each industry may be built on the same web site as practical application of the present invention, and different and/or hierarchical levels of environment management systems may be built in accordance with hierarchies of the industrial organizations. In addition, the internal audit may be conducted not only by the management center but also by the management company using the management computer.

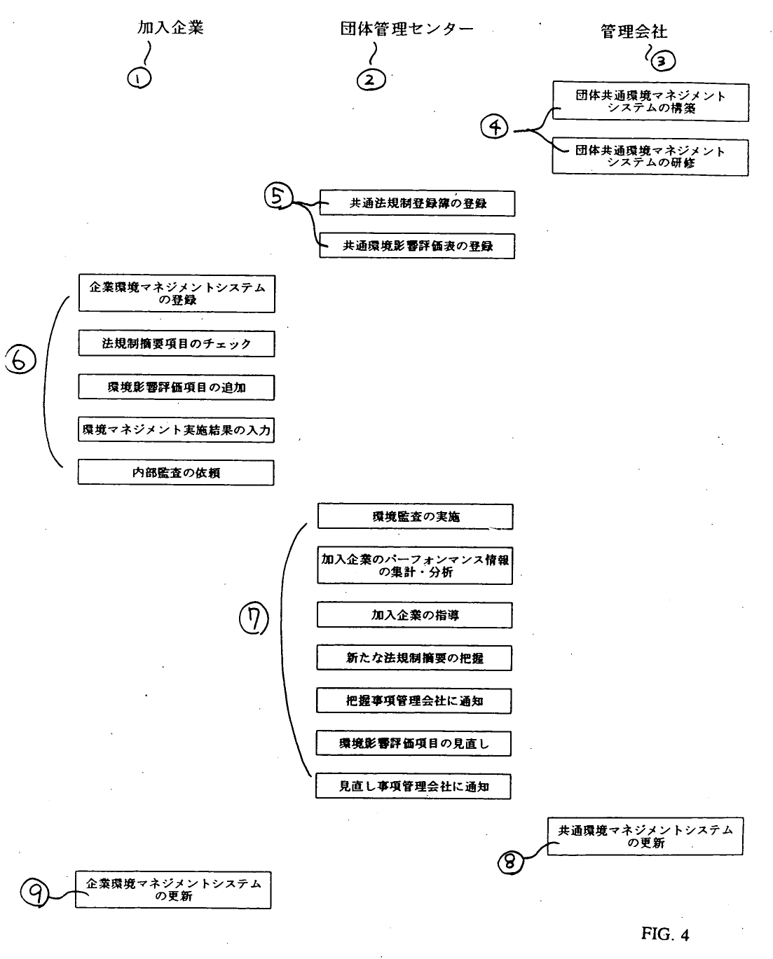

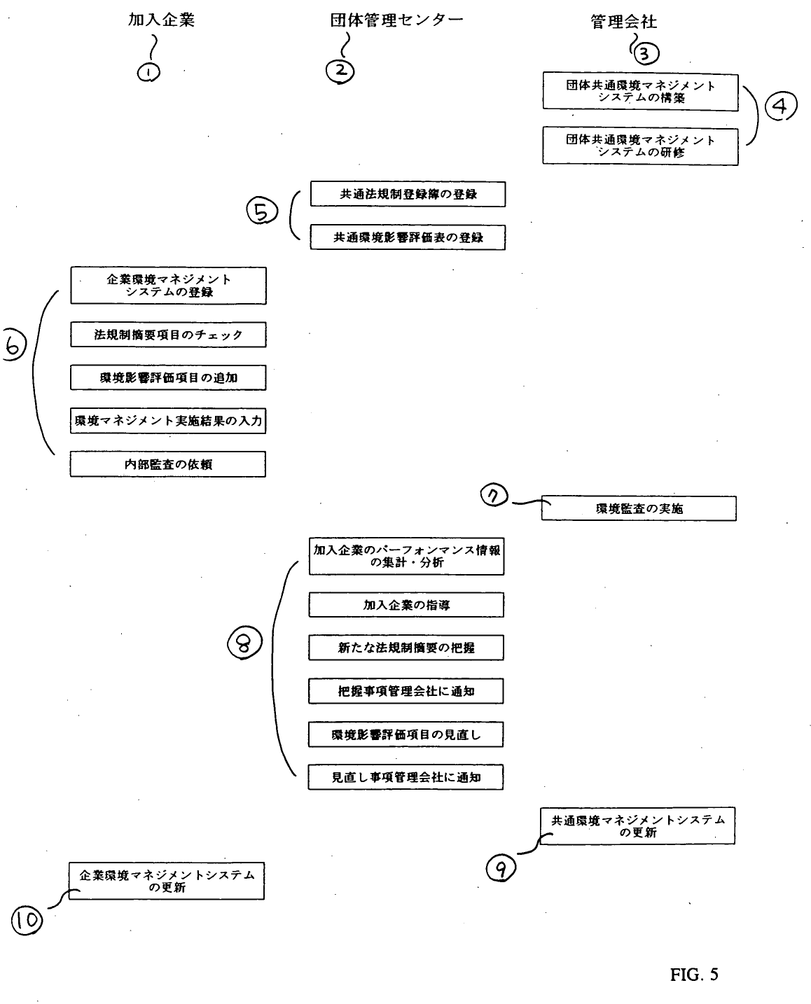

In FIGS. 4 and 5, the operation of the shared environment management system for the industrial organization is explained from viewpoints of a management company, each management center, and each member company. The difference between FIGS. 4 and 5 is that the management company conducts an environmental audit in FIG. 5 and the management center conducts an environmental audit in FIG. 4.

The operation of the shared environment management system for the industrial organization covered by the present invention will be described from the viewpoint of the management company as follows. Within the network, which is composed of the management company, various management centers, and various member companies that participate in the several management centers, the management company provides the shared environment management system for the industrial organization to each management center. The management company receives the results of new applicable regulatory items reviewed and environmental influence assessment items from each management center, and update the shared environment management system for the industrial organization based on the received results. Thus, the management company provides the updated shared environment management system for the industrial organization to each management center. In addition, the management company conducts an environmental audit of each member company in response to a request from the member company or an instruction from each management center. The management company provides the member company training related to the shared environment management system for the industrial organization, as needed or upon request so as to improve the level of the system operations. The training is targeted at each management center and each member company.

The operation of the shared environment management system for the industrial organization covered by the present invention from the viewpoint of each member companies has already been mentioned above.

Next, the operation of the shared environment management system for the industrial organization covered by the present invention from the viewpoint of each management center will be described below. Within the network, which is composed of a management company, various management centers, and various member companies that participate in the several management centers, each management center receives the shared environment management system for the industrial organization from the management company. The management center registers regulations applicable and common to the organizations within each type of industry or each industry, and also registers the environmental influence assessment sheet generally applicable to the industrial organization relevant to such management centers. The registered generally applicable regulations and the common environmental influence assessment sheet are stored. Consequently, the shared environment management system for the industrial organization is provided to each member company.

The member company checks the regulatory items specifically applied to it in relation to and based on the shared environment management system for the industrial organization provided, and adds environmental influence assessment items. The management center receives from the member company the results of the applicable regulatory items and the additional environmental influence assessment items that were checked and added by the member company. In addition, the management center receives results of the environment management executed by the member company. Specifically, the management center receives documents including, but not limited to, the report related to education/training conducted, the minutes that are prepared by the member company. The management center also conducts an environmental audit of the member company. The environmental audit includes the determination of compatibility of various documents of the member companies and the preparation of an audit report based on the determination. The management center notifies the member company of the audit report. This environmental audit can be conducted by the management company.

The management center collects performances of the member companies and analyses them. If new items are found, the management center gives instructions or guidance to the member company in relation to the environment management based on collection and analysis of performance. The management center monitors new regulations. If a new regulation is established, the management center promptly interprets the content of the new regulation and notifies the management company of a new regulatory item that it is present to the application. Likewise, in relation to the new regulation, the management center reviews the environmental influence assessment items and notifies the management company of the reviewed results. At the same time, the management center may instruct the management company to correct and update the shared environment management system for the industrial organization. The management company corrects and updates the shared environment management system for industrial organization based on the application of the new regulation and the reviewed results of the environmental influence assessment items.

The present invention can be characterized by the fact that even a small or medium company having insufficient management resources such as staff and funds can obtain an environment management system that is equivalent to the one that is utilized by a larger company that may have sufficient management resources. That is, the present invention provides a standardized organizational environment management system that will be utilized to create a shared environment management system for each type of industry or each industry. As a result, each member company can build its own environment management system based on the standardized environment management system for the industrial organization. Even if the member company cannot assign an internal auditor due to the limitations of human resources, an internal audit can be conducted by an auditor who belongs to the management center, because there is a common element of the standardized shared environment management system for the industrial organization. Furthermore, since the present invention has a mechanism in which each management center can interpret the content of the environment management system of each member company, the management center, from time to time, can give instructions or guidance to each member company and this leads to the improvement of the level of the entire industry. Even a small or medium company can easily build its own environment management system to the certain level at low cost, and the level of the entire industry to which the small or medium company belongs is eventually improved, accordingly.

Remarks of the Drawings

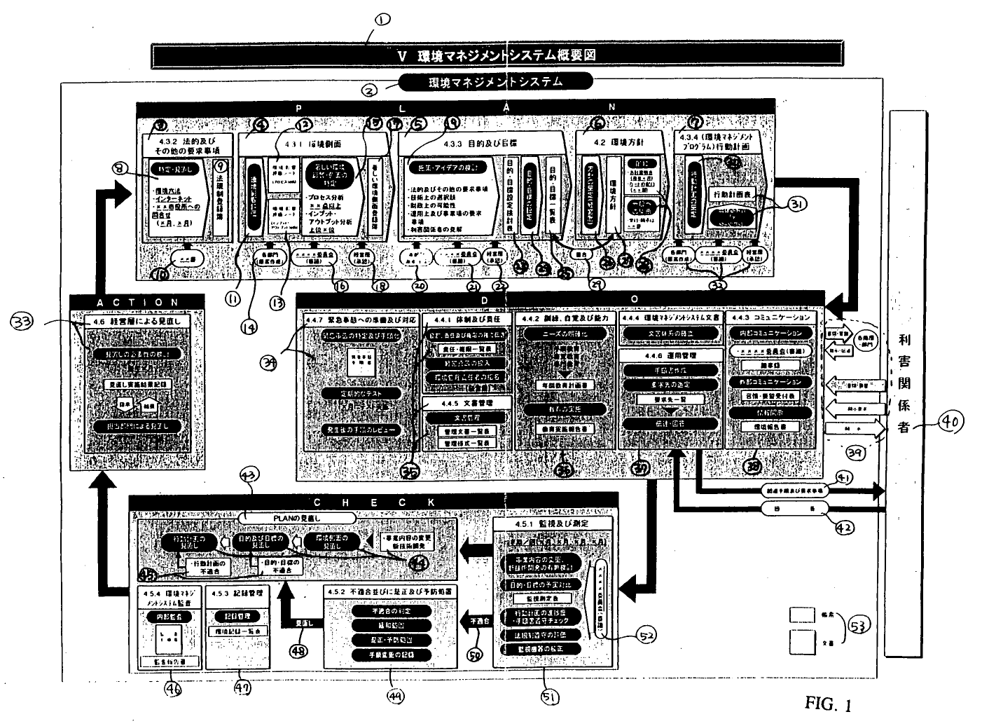

FIG. 1

1 SCHEMATIC DIAGRAM OF ENVIRONMENT MANAGEMENT SYSTEM

2 ENVIRONMENT MANAGEMENT SYSTEM

3 LEGAL AND OTHER REQUIREMENTS

4 ENVIRONMENTAL ASPECTS

5 PURPOSE AND GOAL

6 ENVIRONMENTAL POLICY

7 (ENVIRONMENT MANAGEMENT PROGRAM) ACTION PLAN

8 SPECIFY AND REVIEW

SIX MAJOR ENVIRONMENTAL LAWS

INTERNET

INQUIRY TO XX MUNICIPAL OFFICE (X (MONTH), X (MONTH))

9 LEGAL REGULATION REGISTRATION LIST

10 XX DEPARTMENT

11 ENVIRONMENTAL INFLUENCE EVALUATION

12 ENVIRONMENTAL INFLUENCE EVALUATION SHEET

(PROCESS ANALYSIS)

13 ENVIRONMENTAL INFLUENCE EVALUATION SHEET

(INPUT/OUTPUT ANALYSIS)

14 EACH DEPARTMENT (CREATION OF DRAFT)

15 SPECIFY GREAT ENVIRONMENTAL INFLUENCE AND ASPECT

PROCESS ANALYSIS (EQUAL TO OR HIGHER THAN XX POINTS)

INPUT/OUTPUT ANALYSIS

HIGHER XX

16 XXXX COMMITTEE (CONSULTATION)

17 GREAT ENVIRONMENTAL ASPECT REGISTRATION LIST

18 MANAGEMENT (APPROVAL)

19 CONSIDER MEASURES AND IDEAS

LEGAL AND OTHER REQUIREMENTS, TECHNICAL OPTIONS

FINANCIAL PROBABILITIES

OPERATIONAL AND BUSINESS REQUIREMENTS

OPINIONS OF INTEREST PARTIES

20 EACH DEPARTMENT (CREATION OF DRAFT)

21 XXX COMMITTEE (CONSULTATION)

22 MANAGEMENT (APPROVAL)

23 PURPOSE AND TARGET SETTING CONSIDERATION SHEET

24 SET PURPOSE AND TARGET

25 PURPOSE AND TARGET LIST

26 SET POLICY (MANAGEMENT)

27 ENVIRONMENTAL POLICY

28 MAKE WIDELY KNOWN

POLICY EXPLANATION MEETING (X (MONTH) ANNUALLY), DISTRIBUTION OF CARDS (XX DEPARTMENT)

DISCLOSURE TO PUBLIC, XX DEPARTMENT IS RESPONSIBLE FOR RECEPTION AND DISCLOSURE

29 COMPATIBILITY

30 SET ACTION PLAN

31 ACTION PLAN SHEET REVISE ACCORDING TO PROJECT

32 EACH DEPARTMENT (CREATION OF DRAFT)

XXXX COMMITTEE (CONSULTATION)

MANAGEMENT (APPROVAL)

33 REVIEW BY MANAGEMENT

CONSIDER NECESSITY OF REVIEW

X (MONTH) ANNUALLY

REVIEWING RESULT RECORD

INSTRUCTION

RESULT

REVIEW BY DEPARTMENT IN CHARGE

34 PREPARATION FOR AND DEALING WITH STATE OF EMERGENCY

SPECIFY STATE OF EMERGENCY AND MAKE PROCEDURES ON STATE OF EMERGENCY

STATE OF EMERGENCY PROCEDURAL DOCUMENT

REGULAR TEST

TEST IS CONDUCTED IN X (MONTH)

REVIEW PROCEDURES AFTER OCCURRENCE

35 STRUCTURE AND RESPONSIBILITY

ESTABLISH AND CONVEY ROLE

RESPONSIBILITY, AND RIGHT, RESPONSIBILITY/RIGHT LIST

INPUT MANAGEMENT RESOURCES

DESIGNATE PERSON IN CHARGE OF ENVIRONMENT MANAGEMENT

(ZONE OF MANAGEMENT)

MANAGEMENT

DOCUMENT MANAGEMENT

MANAGEMENT DOCUMENT LIST

MANAGEMENT STYLE LIST

36 TRAINING, AWAKENING, AND ABILITY

CLARIFY NEEDS

PROCEDURAL EDUCATION

AWAKENING EDUCATION

SPECIAL EDUCATION

ANNUAL EDUCATION PLAN

CONDUCT EDUCATION

EDUCATION CONDUCTING REPORT

37 ENVIRONMENT MANAGEMENT SYSTEM DOCUMENT

ESTABLISH DOCUMENT SYSTEM

OPERATION AND MANAGEMENT

CREATE PROCEDURAL DOCUMENT

SELECT REQUEST DESTINATIONS

REQUEST DESTINATION LIST

CONVEY AND REPLY

38 COMMUNICATION

INTERNAL COMMUNICATION

XXXX COMMITTEE (CONSULTATION)

MINUTES

EXTERNAL COMMUNICATION

COMPLAINT AND DEMAND RECEPTION SHEET

INFORMATION DISCLOSURE, ENVIRONMENTAL

REPORT

39 COMPLAINT/DEMAND

INSTRUCTION/CONVEYANCE

EACH HIERARCHY/DEPARTMENT

COMPLAINT/DEMAND

REQUEST OF DISCLOSURE, DISCLOSURE

40 PARTY CONCERNED

41 RELEVANT PROCEDURES AND REQUIREMENTS

42 REPLY

43 REVIEW PLAN

44 REVIEW ACTION PLAN

REVIEW PURPOSE AND TARGET

REVIEW ENVIRONMENTAL ASPECTS

CHANGE BUSINESS CONTENTS AND DEVELOP NEW TECHNOLOGY,

45 ACTION PLAN IS INCOMPATIBLE

PURPOSE AND OBJECT ARE INCOMPATIBLE

46 ENVIRONMENT MANAGEMENT SYSTEM AUDIT

AUDIT PROCEDURAL DOCUMENT

AUDIT REPORT

47 RECORD AND MANAGEMENT

RECORD AND MANAGE

ENVIRONMENTAL RECORD LIST

48 REVIEW

49 INCOMPATIBILITY, CORRECTION, AND PREVENTIVE

MEASURES

DETERMINE INCOMPATIBILITY

TAKE ALLEVIATING MEASURES

TAKE CORRECTION AND PREVENTIVE MEASURES

RECORD PROCEDURAL CHANGE

50 INCOMPATIBLE

51 MONITORING AND MEASUREMENT

QUARTER/NUMBER OF TIMES (X, X, X, X (MONTH))

CHANGE BUSINESS CONTENTS AND CONSIDER

WHETHER TO DEVELOP NEW TECHNOLOGY

COMPARE EXPECTED PURPOSE AND TARGET WITH

ACTUAL PURPOSE AND TARGET

MONITORING AND MEASUREMENT SHEET

CHECK PROGRESS OF ACTION PLAN AND WHETHER

PROCEDURAL DOCUMENT IS OBSERVED

EVALUATE OBSERVANCE OF LEGAL REGULATIONS

CORRECT MONITORING EQUIPMENT

52 XXXX COMMITTEE (CONSULTATION)

53 SHEETS

DOCUMENTS

FIG. 2

1 MANAGEMENT COMPUTER

2 COMMON DATA

3 INDIVIDUAL DATAA

4 INDIVIDUAL DATA B

5 ORGANIZATION WEB SITE

6 ORGANIZATION COMPUTER

7 AUDIT COMPUTER

8 COMPUTER OF MEMBER COMPANY A

9 COMPUTER OF MEMBER COMPANY B

FIG. 3

1 DEPARTMENT

2 ENVIRONMENTAL INFLUENCE EVALUATION SHEET

3 DEPARTMENT ATTACHED

NAME OF EMPLOYEE

DATE OF CREATION

4 THEME OF EXAMINATION

5 ENVIRONMENTAL ASPECT

6 ENVIRONMENTAL INFLUENCE

7 DIRECT

8 INDIRECT

9 ITEMS OF EXAMINATION

10 SPECIFYING

11 STATE OF EMERGENCY

12 GREAT

13 REASON OF SPECIFYING

14 REMARKS

15 MATTERS TO BE CONSIDERED AS THEME OF EXAMINATION,

(1) OCCURRENCE OF PAST SERIOUS ACCIDENT (IN OUR COMPANY OR THE OTHER COMPANY)

(2) BUSINESS RELATED (OPERATION CONTENTS, DEVICES, MACHINES),

(3) MATTERS CONSIDERED NECESSARY IN LIGHT OF INDUSTRIALLY AND SOCIALLY ACCEPTED IDEAS

(4) DEMAND FROM PARTY CONCERNED

(5) ENVIRONMENTALLY USEFUL MATTERS

(6) OTHERS (INTENTION OF MANAGEMENT, GENERIC CONCEPT, ETC.)

16 MATTERS TO BE CONSIDERED AS ENVIRONMENTAL INFLUENCES

AIR POLLUTION

WATER POLLUTION

GROUND POLLUTION

NOISE

REVERBERATION

FOUL SMELL

LAND SUBSIDENCE

INCREASE OF WASTE

CONSUMPTION OF ENERGY

EXHAUSTION OF NATURAL RESOURCES

OZONE DEPLETION

GLOBAL WARMING

17 MATTERS TO BE CONSIDERED IN DETERMINING WHETHER ENVIRONMENTAL ASPECT/INFLUENCE IS GREAT

(1) ENVIRONMENTAL LOAD IS HEAVY OR GREAT REDUCTION OF ENVIRONMENTAL LOAD IS EXPECTED

(2) INFLUENCE ON CLIENT/PARTY CONCERNED

(3) EXPECTATION OF COST REDUCTION

(4) EXPECTATION OF BUSINESS IMPROVEMENT

(5) MERIT/DEMERIT IN BUSINESS

(6) OTHERS

18 REASON THAT ENVIRONMENTAL ASPECT/INFLUENCE IS SPECIFIED AS GREAT ENVIRONMENTAL ASPECT/INFLUENCE

CLEARLY EXPLAIN REASON THAT ENVIRONMENTAL ASPECT/INFLUENCE IS SPECIFIED AS GREAT ENVIRONMENTAL ASPECT/INFLUENCE

FIG. 4

1 MEMBER COMPANY

2 ORGANIZATION MANAGEMENT CENTER

3 MANAGEMENT COMPANY

4 BUILD SHARED ENVIRONMENT MANAGEMENT SYSTEM BY ORGANIZATION

PROVIDE TRAINING FOR SHARED ENVIRONMENT MANAGEMENT SYSTEM BY ORGANIZATION

5 REGISTER COMMON LEGAL REGULATIONS

REGISTER COMMON ENVIRONMENTAL INFLUENCE EVALUATION SHEET

6 REGISTER ENVIRONMENT MANAGEMENT SYSTEM OF MEMBER COMPANY

CHECK LEGAL REGULATION APPLICATION ITEMS

ADD ENVIRONMENTAL INFLUENCE EVALUATION ITEMS

INPUT ENVIRONMENT MANAGEMENT EXECUTION RESULT

REQUEST INTERNAL AUDIT

7 CONDUCT ENVIRONMENTAL AUDIT

AGGREGATE AND ANALYZE PERFORMANCE INFORMATION ON MEMBER COMPANY

DIRECT MEMBER COMPANY

GRASP APPLICATION OF NEW LEGAL REGULATIONS

NOTIFY MANAGEMENT COMPANY OF GRASPED MATTERS

REVIEW ENVIRONMENTAL INFLUENCE EVALUATION ITEMS

NOTIFY MANAGEMENT COMPANY OF REVIEWED MATTERS

8 UPDATE SHARED ENVIRONMENT MANAGEMENT SYSTEM

9 UPDATE ENVIRONMENT MANAGEMENT SYSTEM OF MEMBER COMPANY

FIG. 5

1 MEMBER COMPANY

2 ORGANIZATION MANAGEMENT CENTER

3 MANAGEMENT COMPANY

4 BUILD SHARED ENVIRONMENT MANAGEMENT SYSTEM BY ORGANIZATION

PROVIDE TRAINING FOR SHARED ENVIRONMENT MANAGEMENT SYSTEM BY ORGANIZATION

5 REGISTER COMMON LEGAL REGULATIONS

REGISTER COMMON ENVIRONMENTAL INFLUENCE EVALUATION SHEET

6 REGISTER ENVIRONMENT MANAGEMENT SYSTEM OF MEMBER COMPANY

CHECK LEGAL REGULATION APPLICATION ITEMS

ADD ENVIRONMENTAL INFLUENCE EVALUATION ITEMS

INPUT ENVIRONMENT MANAGEMENT EXECUTION RESULT

REQUEST INTERNAL AUDIT

7 CONDUCT ENVIRONMENTAL AUDIT

8 AGGREGATE AND ANALYZE PERFORMANCE INFORMATION ON MEMBER COMPANY, DIRECT MEMBER COMPANY

GRASP APPLICATION OF NEW LEGAL REGULATIONS

NOTIFY MANAGEMENT COMPANY OF GRASPED MATTERS

REVIEW ENVIRONMENTAL INFLUENCE EVALUATION ITEMS

NOTIFY MANAGEMENT COMPANY OF REVIEWED MATTERS

9 UPDATE SHARED ENVIRONMENT MANAGEMENT SYSTEM

10 UPDATE ENVIRONMENT MANAGEMENT SYSTEM OF MEMBER COMPANY

1. A shared environment management system by organization in a network consisting of a management company, a plurality of organization management centers, and a plurality of member companies belonging to each of the organization management centers, each of the organization management centers comprising:
means for receiving the shared environment management system by organization from the management company;
means for inputting legal regulations commonly applicable to the organization;
means for storing the legal regulations commonly applicable to the organization;
means for inputting an environmental influence evaluation table common to the organization;
means for storing the environmental influence evaluation table common to the organization;
means for providing the shared environmental management system by organization to each of the member companies;
means for receiving a result of checking legal regulation application items from each of the member companies;
means for receiving added environmental influence evaluation items;
means for receiving a result of conducting environment management from each of the member companies;
means for collecting and analyzing performances of each of the member companies;
means for instructing each of the member companies based on results of collection and analysis;
means for interpreting application of new legal regulations, and for notifying the management company of application items of the new legal regulations; and
means for reviewing environmental influence evaluation items, and for notifying the management company of reviewed results.

2. The shared environment management system by organization according to claim 1, comprising:
means for conducting an environmental audit of each of the member companies.

3. The shared environment management system by organization according to claim 1, wherein the means for receiving the result of conducting the environment management from each of the member companies comprises:
means for receiving an education conducting report created by each of the member companies; and
means for receiving minutes created by each of the member companies.

4. The shared environment management system by organization according to claims 1, wherein each of the organization management centers further comprises:
means for urging the management company to update the shared environment management system based on the newly interpreted application of the new legal regulations and the reviewed environmental influence evaluation items; and
means for urging the management company to urge each of the member companies to update the shared environment management system.

5. The shared environment management system by organization according to claims 1, wherein each of the organization management centers further comprises:
means for urging the management company to conduct the environmental audit of each of the member companies in response to a request from each of the member companies.

6. The shared environment management system by organization according to claims 1, wherein each of the organization management centers further comprises:
means for urging the management company to update the shared environment management system based on the newly interpreted application of the legal regulations and the reviewed environmental influence evaluation items.

7. The shared environment management system by organization according to claims 2, wherein the means for conducting the environmental audit of each of the member companies comprises:
means for determining admissibility of various documents of each of the member companies;
means for creating an audit report; and
means for notifying each of the member companies of the created audit report.

8. The shared environment management system by organization according to claims 1, wherein, in the network consisting of the management company, the plurality of organization management centers, and the plurality of member companies belonging to each of the organization management centers, the plurality of organization management centers provide a hierarchically higher organization management center according to an industry type or an industry of each organization management center.

9. A shared environment management system by organization in a network consisting of a management company, a plurality of organization management centers, and a plurality of member companies belonging to each of the organization management centers, the management company comprising:
means for providing the shared environment management system by organization to each of the organization management centers;
means for receiving new legal regulation application items from each of the organization management centers;
means for receiving a review result of environmental influence evaluation items from each of the organization management centers;
means for updating the shared environment management system by organization; and
means for providing the updated shared environment management system by organization to each of the organization management centers.

10. The shared environment management system by organization according to claim 9, wherein the management company comprises means for conducting an environmental audit of each of the member companies.

11. The shared environment management system by organization according to any one of claims 1, wherein each of the organization management centers comprises:
means for receiving the updated shared environment management system by organization; and
means for providing the updated shared environment management system by organization to each of the member companies.
